(19) United States
(12) Patent Application Publication
(10) Pub. No.: US 2008/0150311 A1
(43) Pub. Date: Jun. 26, 2008

(54) Articulating Fascia and Storage System for a Vehicle

(76) Inventors: Douglas J. Quigley, Rochester, MI (US); Robert Smyczynski, Metamora, MI (US); Michael A. Kornilov, Bruce, MI (US); Todd McKinzie, Goodrich, MI (US); Scott M. Krugger, Macomb, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 11/614,575

(22) Filed: Dec. 21, 2006

(51) Int. Cl. B62D 33/03

(52) U.S. Cl. 296/57.1; 296/146.8; 296/146.9

(57) ABSTRACT

A vehicle includes a closure panel movable between an open position and a closed position and a fascia disposed adjacent to the closure panel and movable between a closed position and an open position. The fascia is articulated into the open position prior to the closure panel being moved from the closed position to the open position.

### FIELD OF THE INVENTION

The present invention relates to storage systems and more particularly to a storage system for a vehicle having an articulating fascia.

### BACKGROUND OF THE INVENTION

Conventional trucks and sport utilities may include an access panel such a tailgate that permits selective entry to a storage area of the vehicle. The access panel is typically movable between a closed position and an open position and may be rotatably attached to a side or rear portion of the vehicle by a pivot. The pivot may be disposed adjacent to a bottom portion of the access panel to allow the access panel to articulate relative to the vehicle between the closed position and the horizontal position.

Movement of the access panel is accommodated by providing a gap generally between a bottom portion of the access panel and a top surface of a bumper of the vehicle to provide sufficient clearance for movement of the access panel between the closed position and the open position. While the gap sufficiently permits movement of the access panel relative to the vehicle, the gap is visible when the access panel is in the closed position and therefore detracts from the overall appearance of the vehicle.

As noted above, when an access panel is in a closed position, a rear portion of a truck or a sport utility vehicle is open such that large objects may be loaded into a storage space of the vehicle. For example, when the access panel is moved from the closed position to the open position, a surface of the access panel is generally flush with the surface of a storage space of the vehicle to permit large items to be slid over the access panel and into the storage space. While cooperation between the storage space and the access panel permits large objects to be stored in the storage space of the vehicle, rotation of the access panel from the closed position to the open position is typically limited to ninety degrees. Further rotation of the access panel relative to the vehicle beyond the initial ninety degrees is not permitted due to interference between the access panel and the bumper of the vehicle.

While conventional trucks and sport utility vehicles permit large objects to be loaded into a storage space of the vehicle when the access panel is in an open position, the ability of the vehicle to store a large and/or bulky items is generally limited to the size of the storage space. Conventional vehicles do not include a separate compartment within or around the vehicle to store large and/or bulky items other than the storage space accessible by articulation of the access panel from the closed position to the open position.

### SUMMARY OF THE INVENTION

A vehicle includes a closure panel movable between an open position and a closed position and a fascia disposed adjacent to the closure panel and movable between a closed position and an open position. The fascia is articulated into the open position prior to the closure panel being moved from the closed position to the open position.

A vehicle includes a storage compartment having a load floor and a closure panel movable relative to the storage compartment between a closed position and an open position. The closure panel is positioned at an angle substantially equal to ninety degrees relative to the load floor when the closure panel is in the closed position and is rotated greater than ninety degrees from the closed position into the open position.

### BRIEF DESCRIPTION OF THE DRAWINGS

The present invention will become more fully understood from the detailed description and the accompanying drawings, wherein:

FIG. 1 is a perspective view of a vehicle incorporating an articulating fascia and storage system in accordance with the principles of the present invention;

FIG. 2 is a partial side view of the vehicle of FIG. 1 showing the fascia of FIG. 1 in a closed position;

FIG. 3 is a partial side view of the vehicle of FIG. 1 with the fascia of FIG. 1 articulated into an open position;

FIG. 4 is a partial perspective view of the vehicle of FIG. 1 with the fascia of FIG. 1 in an open position;

FIG. 5 is a perspective view of the vehicle of FIG. 1 with a rear closure panel in an open position;

FIG. 6 is a perspective view of the vehicle of FIG. 1 with a closure panel in an open and extended position;

FIG. 7 is a perspective view of the vehicle of FIG. 1 with a closure panel of the vehicle in an open, extended, and articulated position;

FIG. 8 is a perspective view of the storage system and associated frame of FIG. 1;

FIG. 9 is a rear view of the frame of FIG. 8 detailing the storage area of the frame;

FIG. 10 is a perspective view of the frame of FIG. 8;

FIG. 11 is a perspective view of the vehicle of FIG. 1 with a body of the vehicle removed to show the relationship between the storage system and a frame of the vehicle; and

FIG. 12 is a rear view of the vehicle of FIG. 1 with the fascia in an open position to show the storage system.

### DETAILED DESCRIPTION OF THE PREFERRED EMBODIMENTS

The following description of the preferred embodiment(s) is merely exemplary in nature and is in no way intended to limit the invention, its application, or uses.

With reference to the figures, a vehicle 10 is provided and includes a closure panel 12, a storage compartment 14, and a fascia 16. The fascia 16 is movable between an open position allowing access to the storage compartment 14 and a closed position restricting access to the storage compartment 14. The fascia 16 cooperates with the closure panel 12 and engages at least one surface of the closure panel 12 when the closure panel 12 is in a closed position and the fascia 16 is in the closed position. The fascia 16 is rotated relative to the vehicle into the open position prior to the closure panel 12 being rotated from the closed position to an open position and permits the closure panel 12 to be rotated greater than ninety degrees relative to the vehicle 10 from the closed position to the open position.

The closure panel 12 is disposed adjacent to a load floor 18 of the vehicle and is supported by a hinge 20. The closure panel 12 includes a bottom surface 22, a load surface 24, a top surface 26, and an outer surface 28. The bottom surface 22 is positioned adjacent to the fascia 16 while the load surface 24 is positioned adjacent to the load floor 18. The top surface 26 is positioned on an opposite side of the closure panel 12 from the bottom surface 22 while the outer surface 28 is positioned on an opposite side of the closure panel 12 from the load surface 24.

The closure panel 12 may also be attached to the vehicle 10 by a series of cables 30 that cooperate with the hinge 20 to support the closure panel 12 when the closure panel 12 is in the open position. While a hinge 20 is disclosed, any mechanism that allows rotation of the closure panel 12 relative to the vehicle 10 such as a pair of hinges 20 located on opposite sides of the closure panel 12, should be considered within the scope of the present invention.

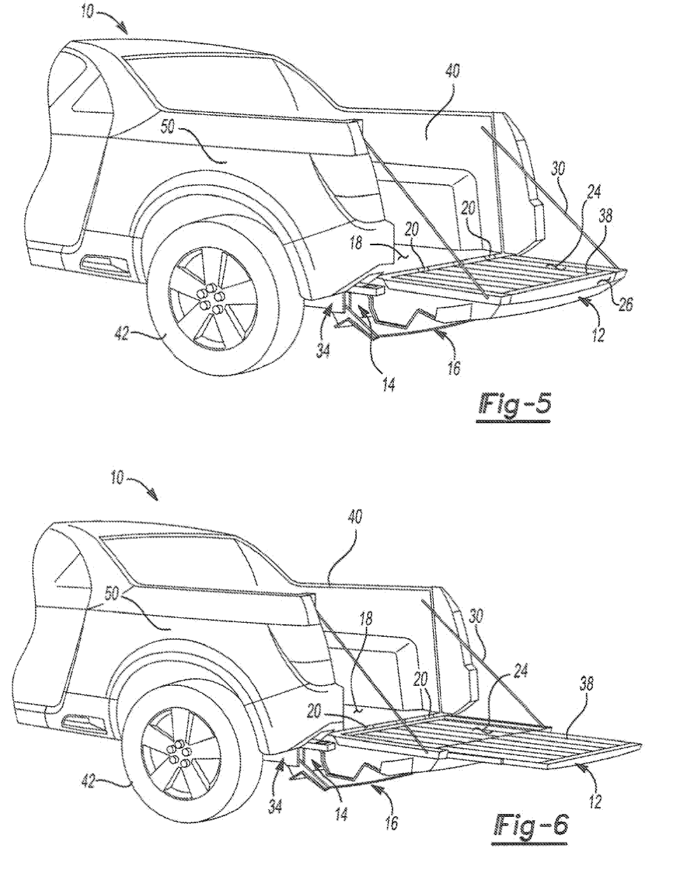

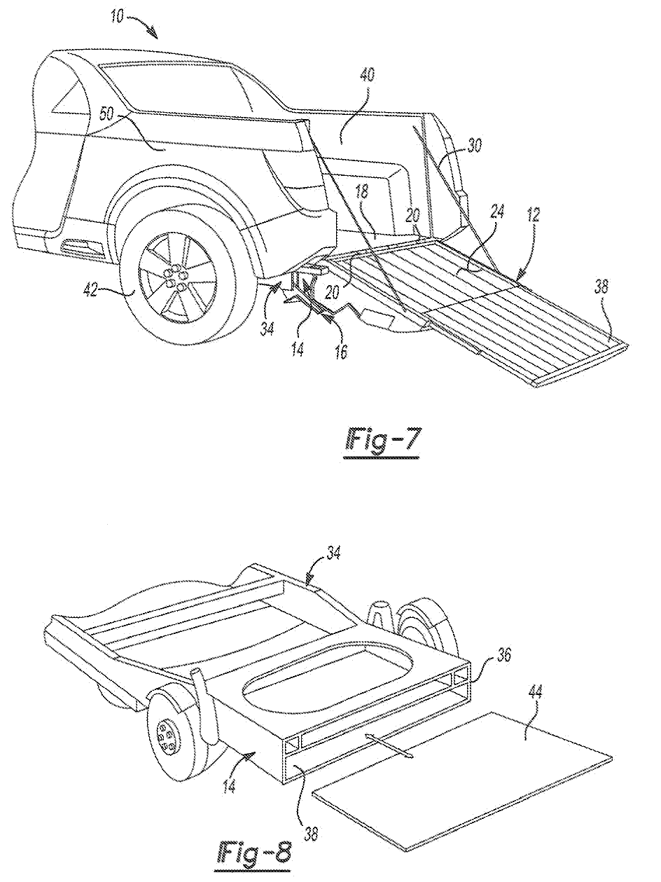

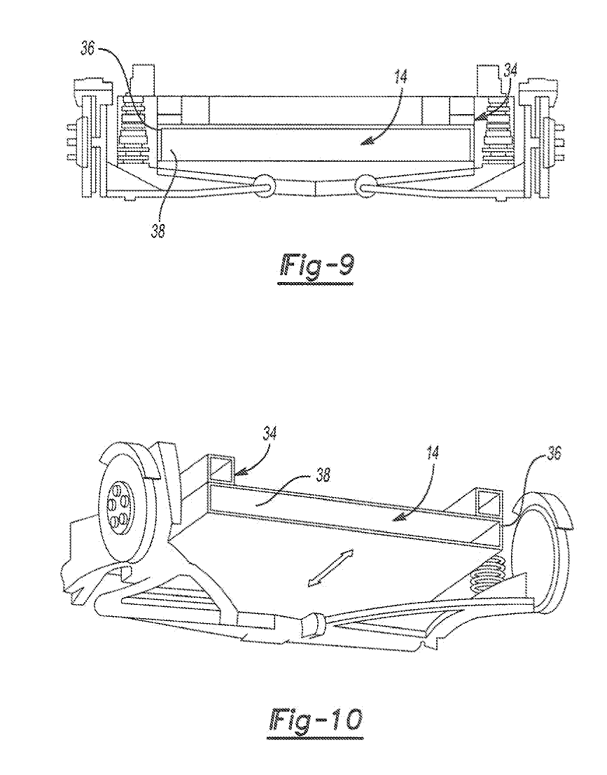

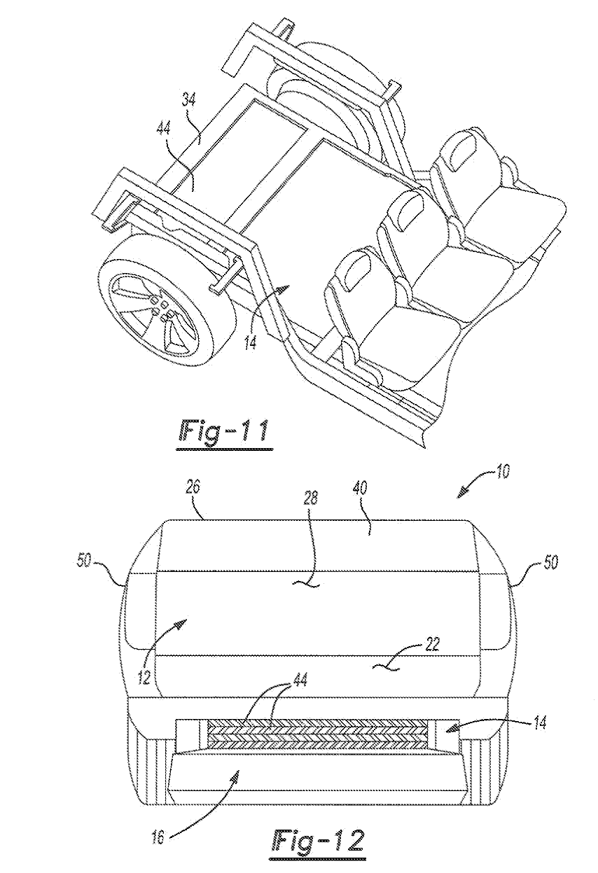

The closure panel 12 may also include an extension 32 movably attached to the load surface 24 of the closure panel 12. The extension 32 may be pivotably or slidably attached to the closure panel 12 and may be movable between a stowed position (FIG. 5) and an extended position (FIG. 6). The extension 32 may be moved into the extended position to further lengthen the closure panel 12 and, thus, the load floor 18 of the vehicle 10. Furthermore, as will be described below, when the closure panel 12 is rotated greater than ninety degrees relative to the vehicle 10 from the closed position to the open position, the load surface 24 of the closure panel 12 is positioned at an angle relative to the load floor 18. In this position, moving the extension 32 from the stowed position to the extended position allows the extension 32 to engage the ground and cooperate with the closure panel 12 to create a ramp (FIG. 7) leading into the load floor 18 of the vehicle 10.

The storage compartment 14 is located under the load floor 18 of the vehicle 10 and is accessible when the fascia 16 is moved from the closed position to the open position. The storage compartment 14 may be defined by a frame 34 of the vehicle 10, whereby side rails 36 of the frame 34 define a pair of opposing channels 36 that cooperate to define the overall shape and size of the storage compartment 14. In one configuration, the load floor 18 of the vehicle 10 is a floor of a truck bed 40. In this configuration, the storage compartment 14 is located generally under the truck bed 40 on an opposite side of the truck bed from the load floor 18.

The frame 34 extends under the truck bed 40 such that the side rails 36 are positioned adjacent to a pair of rear wheels 42 of the vehicle 10. Providing the vehicle 10 with the storage compartment 14 located between the rear wheels 42 and under the truck bed 40 utilizes space that is typically not used in a conventional vehicle. The position of the side rails 36 relative to one another and the overall size of the channels 38 cooperate to accommodate large and/or bulky items such as, for example, four-foot by eight-foot sheets of plywood and/or drywall (schematically represented by reference number 44). The channels 38 may be of a sufficient height to accommodate more than one sheet of plywood and/or drywall 44 such that the sheets of plywood and/or drywall 44 may be stacked within the channels 38 and transported within the storage compartment 14 under the truck bed 40. Positioning such material within the storage compartment 14 under the truck bed 40 allows other cargo to be placed in the vehicle 10 generally within the truck bed 40 and on the load floor 18.

The fascia 16 may be moved between the closed position restricting entry into the storage compartment 14 and the open position permitting entry into the storage compartment 14. When the fascia 16 is in the open position, the closure panel 12 may be rotated from the closed position into the open position relative to the vehicle 10. The fascia 16 is rotatably attached to the vehicle 10 by a pair of hinges 46 and includes an engagement surface 48 that selectively contacts at least one of the bottom surface 22 and the outer surface 28 of the closure panel 12 when the closure panel 12 is in the closed position and the fascia 16 is in the closed position. Contact between the engagement surface 48 of the fascia 16 and at least one of the bottom surface 22 of the closure panel 12 and the outer surface 28 of the closure panel 12 provides the vehicle 10 with a streamlined and aesthetically pleasing exterior surface when the closure panel 12 is in the closed position and the fascia 16 is in the closed position. Furthermore, such engagement between the fascia 16 and the closure panel 12 hides the hinge 20 of the closure panel 12 from view when the closure panel 12 is in the closed position. Similarly, engagement between the fascia 16 and the closure panel 12 also hides from view the hinges 46 of the fascia 16 when the fascia 16 is in the closed position.

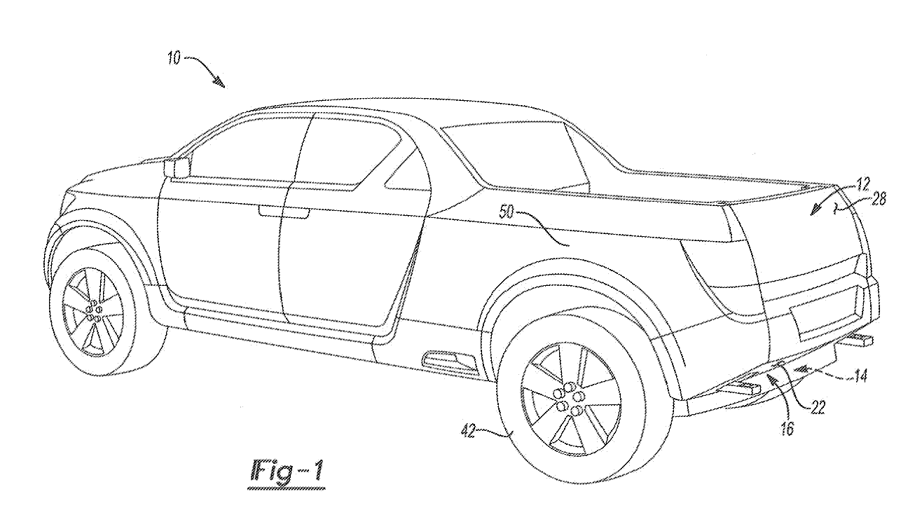

As shown in FIGS. 1 and 4, the fascia 16 cooperates with the bottom surface 22 and the outer surface 28 of the closure panel 12 to define a rear surface of the vehicle 10, typically defined by a rear bumper (not shown) of a conventional vehicle. Because the fascia 16 cooperates with the closure panel 12 to define the rear end of the vehicle 10, movement of the fascia 16 may be coordinated with movement of the closure panel 12 to permit the closure panel 12 to be rotated into a position such that the load surface 24 of the closure panel 12 is at an angle relative to the load floor 18 of the vehicle 10. In other words, because the fascia 16 is rotated into an open position and away from the bottom surface of the closure panel 12 prior to the closure panel 12 being rotated into the open position, when the closure panel 12 is rotated from the closed position (FIG. 1) to the open position (FIG. 7) the closure panel 12 may be rotated greater than ninety degrees relative to the vehicle 10 as the fascia 16 is rotated away from and provides a clearance to the closure panel 12.

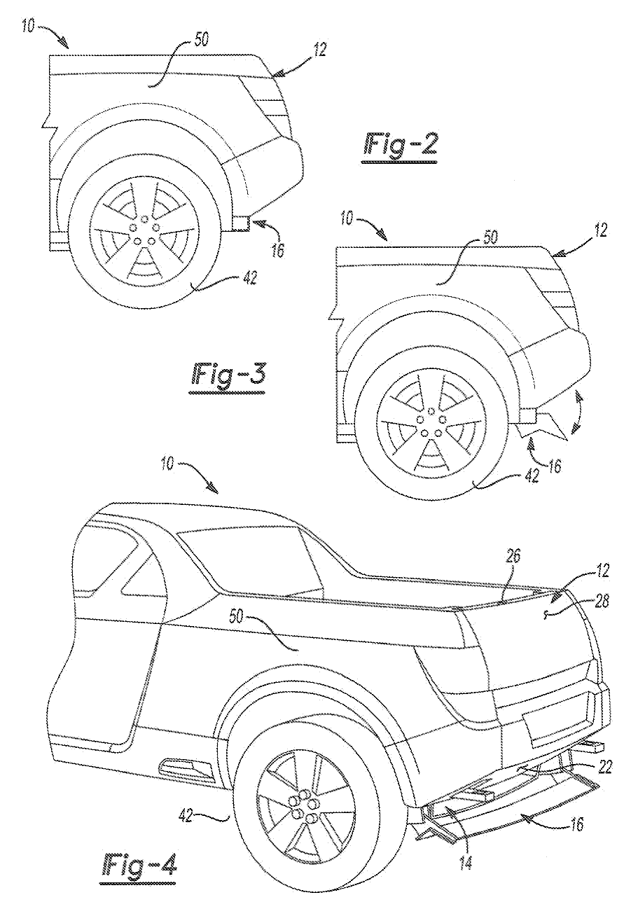

With particular reference to FIGS. 2-8, operation of the closure panel 12 and fascia 16 will be described in detail. When the closure panel 12 is in the closed position and the fascia 16 is similarly in the closed position, the engagement surface 48 of the fascia 16 is in engagement with at least one of the bottom surface 22 and the outer surface 28 of the closure panel 12 such that the vehicle 10 is provided with a streamlined and aesthetically pleasing exterior rear surface. To move the closure panel 12 from the closed position to the open position, a force is applied to the fascia 16 either manually or by an electrically controlled system (not shown) associated with the fascia 16 to move the fascia 16 from the closed position to the open position. Once the fascia 16 has been sufficiently moved from the closed position to the open position and the engagement surface 48 is disengaged from the bottom surface 22 and/or outer surface 28 of the closure panel 12, the closure panel 12 may be rotated from the closed position to the open position relative to the vehicle 10.

The closure panel 12 may be rotted a distance greater than ninety degrees relative to the vehicle 10 such that the load surface 24 of the closure panel 12 is positioned at an angle relative to the load floor 18 of the vehicle 10. Rotating the closure panel 12 a distance greater than ninety degrees relative to the vehicle 10 allows the top surface 26 of the closure panel 12 to generally oppose the ground and allows the extension 32 to be moved into the extended position and engage the ground such that the extension 32 cooperates with the closure panel 12 to provide a ramp leading to the load floor 18 (FIG. 7).

While the closure panel 12 is described above as being rotated greater than ninety degrees relative to the vehicle 10 into the open position, the closure panel 12 may also be rotated into an intermediate position between the closed position and the open position (FIG. 5). The closure panel 12 may be rotated from the closed position to the open position, whereby the closure panel 12 is rotated substantially ninety degrees relative to the vehicle 10. In the intermediate position, the load surface 24 is substantially flush with the load floor 18 of the vehicle 10 to provide the vehicle 10 with a generally flat surface defined by the load floor 18 of the vehicle 10 with a generally flat surface defined by the load floor 18 of the vehicle 10 and the load surface 24 of the closure panel 12. When the closure panel 12 is in the intermediate position, the extension 32 may be moved from the stored position to the extended position to further lengthen the generally flat cargo space of the vehicle 10 defined by the load floor 18 of the vehicle 10, the load surface 24 of the closure panel 12, and the extension 32 (FIG. 6).

In any of the above configurations, the cables 30 cooperate with the hinge 20 of the closure panel 12 to support the closure panel 12 in either the intermediate position or the open position. The cables 30 extend from side panels 50 of the vehicle 10 and may be rotatably attached to the side panels 50 and/or rotatably attached to the closure panel 12 generally proximate to the top surface 26 of the closure panel 12.

To return the closure panel 12 to the closed position, the extension 32 (if in the extended position) is first moved into the retracted position either by rotating or translating the extension 32 relative to the closure panel 12. Once the extension 32 is returned to the retracted position, the closure panel 12 may be rotated from the open position or the intermediate and into the closed position by applying a force to the closure panel 12 and rotating the closure panel 12 relative to the vehicle 10. Upon returning the closure panel 12 to the closed position, a force may be applied to the fascia 16 either manually or by an electrically controlled system such as an electric motor to move the fascia 16 from the open position to the closed position. As described above, when the fascia 16 is returned to the closed position, the engagement surface 48 of the fascia 16 is in contact with at least one of the bottom surface 22 and the outer surface 28 of the closure panel 12.

When the fascia 16 is in the closed position, access to the storage compartment 14 is restricted. To access the storage compartment 14, a force is applied to the fascia 16 either manually or via an electrically controlled device to rotate the fascia 16 from the closed position to the open position. Once the fascia 16 is moved sufficiently into the open position, access to the storage compartment 14 is permitted.

As described above, the side rails 36 of the vehicle 10 are positioned relative to one another such that large and/or bulky objects may be received within the storage compartment 14 and stored generally under the truck bed 40. The channels 38 are positioned relative to one another such that multiple sheets such as plywood and/or drywall 44 may be stacked within the storage compartment 14 and transported with the vehicle 10 generally under the truck bed 40.

Upon loading material into the storage compartment 14, a force may be applied to the fascia 16 to rotate the fascia 16 from the open position to the closed position. Rotating the fascia 16 from the open position to the closed position causes the engagement surface 48 of the fascia 16 to once again engage at least one of the bottom surface 22 and the outer surface 28 of the closure panel 12 to restrict entry into the storage compartment 14. Engagement between the fascia 16 and a closure panel 12 also assists in preventing objects disposed within the storage compartment 14 from being removed from the storage compartment 14 when the fascia 16 is in the closed position and in engagement with the closure panel 12.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A vehicle comprising:
a closure panel movable between an open position and a closed position; and
a fascia disposed adjacent to said closure panel and movable between a closed position and an open position, said fascia being articulated into said open position prior to said closure panel being moved from said closed position to said open position.

2. The vehicle of claim 1, wherein said fascia abuts at least one of a bottom surface and an outer surface of said closure panel when said closure panel is in said closed position and said fascia is in said closed position.

3. The vehicle of claim 1, wherein said closure is rotated greater than ninety degrees when said closure panel is rotated from said closed position to said open position.

4. The vehicle of claim 1, further comprising a storage area including a load floor.

5. The vehicle of claim 4, wherein said closure panel is positioned substantially at a ninety degree angle relative to said load floor when said closure panel is in said closed position and is rotated substantially ninety degrees from said closed position into said open position such that a surface of said closure panel is substantially flush with said load surface.

6. The vehicle of claim 4, wherein said closure panel is positioned substantially at a ninety degree angle relative to said load floor once the closure panel is in said closed position and is rotated more than ninety degrees from said closed position to said open position such that said closure panel is at an angle relative to said load surface when said closure panel is in said open position.

7. The vehicle of claim 4, further comprising a storage compartment disposed below said load surface of said storage compartment.

8. The vehicle of claim 7, wherein access to said storage compartment is permitted when said fascia is in said open position and access to said storage compartment is restricted when said fascia is in said closed position.

9. The vehicle of claim 7, wherein said storage compartment includes opposing channels defining a storage space therebetween.

10. The vehicle of claim 1, wherein said closure panel includes an extension selectively movable relative to said closure panel.

11. The vehicle of claim 1, wherein said closure panel may be rotated greater than ninety degrees from said closed position to said open position and said closure panel includes an extension that may be translated relative to the closure panel such said extension and said closure panel cooperate to form a ramp.

12. A vehicle comprising:
a storage area including a load floor; and
a closure panel movable relative to the storage area between a closed position and an open position, said closure panel being positioned at an angle substantially equal to ninety degrees relative to said load floor when said closure panel is in said closed position and is rotated greater than ninety degrees from said closed position into said open position.

13. The vehicle of claim 12, wherein said closure panel may be rotated from said closed position to an intermediate position prior to achieving said open position.

14. The vehicle of claim 13, wherein said closure panel is rotated relative to said load floor substantial ninety degrees from said closed position to said intermediate position.

15. The vehicle of claim 12, further including an extension selectively movable relative to said closure panel, said extension selectively extending from said closure panel and engaging the ground when said closure panel is in said open position.

16. The vehicle of claim 12, further comprising a fascia movable between an open position and a closed position relative to said storage area and said closure panel.

17. The vehicle of claim 16, wherein said fascia abuts at least one surface of said closure panel when said fascia is in said closed position and said closure panel is in said closed position.

18. The vehicle of claim 16, wherein said fascia is rotated into said open position prior to said closure panel being rotated into said open position.

19. The vehicle of claim 1, further comprising a storage compartment disposed beneath said load floor.

20. The vehicle of claim 19, further comprising a fascia selectably rotatable relative to said storage compartment and said closure panel, said fascia movable between an open position permitting entry into said storage compartment and a closed position restricting entry said storage compartment.
